(19) United States
(12) Patent Application Publication
(10) Pub. No.: US 2016/0222307 A1
(43) Pub. Date: Aug. 4, 2016

(54) FISCHER-TROPSCH DERIVED GAS OIL

(71) Applicant: SHELL OIL COMPANY, Houston, TX (US)

(72) Inventors: Rendert Jan WIERSMA, te Castricum (NL); Johannes TURFBOER, Amsterdam (NL); Robert RIEMERSMA, Amsterdam (NL); Johannes Bernardus Wilhelmus MORSINK, Amsterdam (NL)

(73) Assignee: SHELL OIL COMPANY, Houston, TX (US)

(21) Appl. No.: 15/025,363

(22) PCT Filed: Sep. 25, 2014
(86) PCT No.: PCT/EP2014/070506

§ 371 Date: Mar. 28, 2016

(30) Foreign Application Priority Data
Sep. 30, 2013 (EP) 13186736.8

(51) Int. Cl. C10L 1/04; C09K 3/00; C10M 101/00

(52) U.S. Cl. CPC C10L 1/04; C10M 101/00; C09K 3/00; C10L 2200/0492; C10L 2290/42

(57) ABSTRACT

The present invention provides a Fischer-Tropsch derived gas oil having an initial boiling point of at least 165° C. and a final boiling point of at most 360° C. In another aspect the present invention provides a functional fluid formulation comprising a Fischer-Tropsch derived gas oil having an initial boiling point of at least 165° C. and a final boiling point of at most 360° C.

The present invention relates to a Fischer-Tropsch derived gas oil and a functional fluid formulation comprising the same.

Fischer-Tropsch derived gas oil may be obtained by various processes. A Fischer-Tropsch derived gas oil is obtained using the so-called Fischer-Tropsch process. An example of such process is disclosed in WO 02/070628.

It has now surprisingly been found that specific Fischer-Tropsch derived gas oils can be advantageously used in solvent and functional fluid applications.

To this end, the present invention provides a Fischer-Tropsch gas oil having an initial boiling point of at least 165° C. and a final boiling point of at most 360° C.

An advantage of the present invention is that the Fischer-Tropsch derived gas oil has surprisingly a low viscosity, low pour point while having a high flash point, which combination of properties provides advantages in solvent and functional fluid applications with low viscosity requirements.

Typically, the Fischer-Tropsch derived gas oil according to the present invention has very low levels of aromatics, naphthenics and impurities.

The use of the Fischer-Tropsch derived gas oil thus improves the biodegradability and offers lower toxicity in solvent and/or functional fluid applications.

The Fischer-Tropsch derived gas oil according to the present invention is derived from a Fischer-Tropsch process. Fischer-Tropsch derived gas oil is known in the art. By the term “Fischer-Tropsch derived” is meant that a gas oil, is, or is derived from, a synthesis product of a Fischer-Tropsch process. In a Fischer-Tropsch process synthesis gas is converted to a synthesis product. Synthesis gas or syngas is a mixture of hydrogen and carbon monoxide that is obtained by conversion of a hydrocarbonaceous feedstock. Suitable feedstock include natural gas, crude oil, heavy oil fractions, coal, biomass and lignite. A Fischer-Tropsch derived gas oil may also be referred to as a GTL (Gas-to-Liquids) gas oil.

Fischer-Tropsch derived gas oils are primarily iso-paraffins. Preferably, the Fischer-Tropsch derived gas oil comprises more than 75 wt. % of iso-paraffins, preferably more than 80 wt. %.

According to the present invention, the Fischer-Tropsch derived gas oil has an initial boiling point of at least 165° C. and a final boiling point of at most 360° C. at atmospheric conditions. Suitably, the Fischer-Tropsch derived gas oil has an initial boiling point of at least 170° C. at atmospheric conditions. Further, the Fischer-Tropsch derived gas oil preferably has an initial boiling point of at least 175° C. at atmospheric conditions.

The Fischer-Tropsch derived gas oil preferably has a final boiling point from 333 to 351° C., more preferably from 336 to 348° C., and most preferably from 339 to 345° C. at atmospheric conditions.

By boiling points at atmospheric conditions is meant atmospheric boiling points, which boiling points are determined by ASTM D86.

Preferably, the Fischer-Tropsch gas oil has a T10 vol % boiling point from 198 to 220° C., more preferably from 202 to 216° C., most preferably from 205 to 213° C. and a T90 vol % boiling point from 319 to 333° C., preferably from 321 to 331° C. and more preferably from 323 to 328° C. T10 vol % is the temperature corresponding to the atmospheric boiling point at which a cumulative amount of 10 vol % of the product is recovered. Similarly, T90 vol % is the temperature corresponding to the atmospheric boiling point at which a cumulative amount of 90 vol % of the product is recovered. An atmospheric distillation method ASTM D86 can be used to determine the level of recovery, or alternatively a gas chromatographic method such as ASTM D2887 that has been calibrated to deliver analogous results.

The Fischer-Tropsch derived gas oil comprises preferably paraffins having from 9 to 25 carbon atoms; the Fischer-Tropsch derived paraffin gas oil comprises preferably at least 70 wt. %, more preferably at least 85 wt. %, more preferably at least 90 wt. %, more preferably at least 95 wt. %, and most preferably at least 98 wt. % of Fischer-Tropsch derived paraffins having 9 to 25 carbon atoms based on the total amount of Fischer-Tropsch derived paraffins, preferably based on the amount of Fischer-Tropsch derived paraffins having from 7 to 30 carbon atoms.

Further, the Fischer-Tropsch derived gas oil preferably has a density at 15° C. according to ASTM D4052 from 774 kg/m³ to 779, more preferably from 775 kg/m³ to 778, and most preferably from 776 kg/m³ to 777.

Suitably, the kinematic viscosity at 40° C. according to ASTM D445 is from 2.3 to 2.8 cSt, preferably from 2.4 to 2.7 cSt, and more preferably from 2.5 to 2.6 cSt.

Further, the pour point of the Fischer-Tropsch derived gas oil (according to ASTM D97) is preferably below −10° C., more preferably below −15° C., more preferably below −20° C., more preferably below −22° C., more preferably below −25° C., and most preferably below −36° C. and preferably for at most above −40° C.

Suitably, the cloud point of the Fischer-Tropsch derived gas oil (according to ASTM D2500) is preferably below −10° C., more preferably below −15° C., more preferably below −17° C., more preferably below −20° C., more preferably below −22° C., more preferably below −25° C., and most preferably below −36° C. and preferably for at most above −40° C.

Preferably, the flash point of the Fischer-Tropsch derived gas oil according to ASTM D93 is of at least 68° C., more preferably at least 70° C., and most preferably at least 72° C.

Typically, the flash point of the Fischer-Tropsch derived gas oil according to ASTM D93 is below 85° C., preferably below 75.

The Fischer-Tropsch derived gas oil has a smoke point according to ASTM D1322 of more than 50 mm.

Typically, the Fischer-Tropsch gas oil according to the present invention comprises less than 500 ppm aromatics, preferably less than 200 ppm aromatics, less than 3 ppm sulphur, preferably less than 1 ppm sulphur, and more preferably less than 0.2 ppm sulphur, less than 1 ppm nitrogen and less than 2 wt. % naphthenics.

Further, the Fischer-Tropsch derived gas oil preferably comprises less than 0.1 wt % polycyclic aromatic hydrocarbons, preferably less than 25 ppm polycyclic aromatic hydrocarbons, and more preferably less than 1 ppm polycyclic aromatic hydrocarbons.

The amount of isoparaffins is suitably more than 75 wt % based on the total amount of paraffins having from 9 to 25 carbon atoms, preferably more than 80 wt %.

Further, the Fischer-Tropsch derived gas oil may comprise n-paraffins and cyclo-alkanes.

The preparation of the Fischer-Tropsch derived gas oil having an initial boiling point of at least 165° C. and a final boiling point of at most 360° C. has been described in e.g. WO02/070628.

In a further aspect, the present invention provides a functional fluid formulation comprising a Fischer-Tropsch derived gas oil according to the present invention, further containing an additive compound. Typically, the functional fluid formulations may be used in many areas, for instances oil and gas exploration and production, construction industry, food and related industries, paper, textile and leather, and various household and consumer products. Further, the type of additives used in the functional fluid formulation according to the present invention is dependent on the type of fluid formulation. Additives for functional fluid formulations include, but are not limited to, corrosion and rheology control products, emulsifiers and wetting agents, borehole stabilizers, high pressure and anti-wear additives, de- and anti-foaming agents, pour point depressants, and antioxidants.

An advantage of the use of Fischer-Tropsch derived gas oil in functional fluid formulations is that the Fischer-Tropsch derived gas oil has a low viscosity and a low pour point while having a high flash point.

Typically, this combination of these physical characteristics of Fischer-Tropsch derived gas oil is highly desirable for its use in functional fluid formulations.

In another aspect, the present invention provides the use of the Fischer-Tropsch derived gas oil according to the present invention as a diluent oil or base oil for solvent and/or functional fluid applications.

With the term diluent oil is meant an oil used to decrease viscosity and/or improve other properties of solvent and functional fluid formulations.

With the term base oil is meant an oil to which other oils, solvents or substances are added to produce a solvent or functional fluid formulation.

The advantages of the use of the Fischer-Tropsch derived gas oil as a diluent oil or base oil for solvent and/or functional fluid formulations are the same as described above for functional fluid formulations comprising the Fischer-Tropsch derived gas oil according the present invention, further containing an additive compound.

Preferred solvent and/or functional fluid applications using the Fischer-Tropsch derived gas oil according to the present invention as diluent oil or base oil include, but is not limited to, drilling fluids, heating fuels, lamp oil, barbeque lighters, concrete demoulding, pesticide spray oils, water treatment, cleaners, polishes, car dewaxers, electric discharge machining, transformer oils, silicone mastic, two stroke motor cycle oil, metal cleaning, dry cleaning, lubricants, metal work fluid, aluminium roll oil, explosives, chlorinated paraffins, heat setting printing inks, Timber treatment, polymer processing oils, rust prevention oils, shock absorbers, greenhouse fuels, fracturing fluids, fuel additives formulations.

Typical solvent and functional fluid applications are for example described in “The Index of Solvents”, Michael Ash, Irene Ash, Gower publishing Ltd, 1996, ISBN 0-566-07884-8 and in “Handbook of Solvents”, George Wypych, Willem Andrew publishing, 2001, ISBN 0-8155-1458-1. In a further aspect, the present invention provides the use of the Fischer-Tropsch derived gas oil according to the present invention for improving biodegradability and lower toxicity in solvent and/or functional fluid applications.

As described above, the Fischer-Tropsch derived gas oil has preferably very low levels of aromatics, sulphur, nitrogen compounds and is preferably free from polycyclic aromatic hydrocarbons. These low levels may lead to, but are not limited to, low aquatic toxicity, low sediment organism toxicity and low terrestrial ecotoxicity of the Fischer-Tropsch derived gas oil. The molecular structure of the Fischer-Tropsch derived gas oil according to the present invention may lead to the readily biodegradability of the Fischer-Tropsch derived gas oil.

The present invention is described below with reference to the following Examples, which are not intended to limit the scope of the present invention in any way.

### EXAMPLES

### Example 1

### Preparation of a Fischer-Tropsch Derived Gas Oil Having an Initial Boiling Point of at Least 165° C. and a Final Boiling Point of at Most 360° C.

A Fischer-Tropsch product was prepared in a process similar to the process as described in Example VII of WO-A-9934917, using the catalyst of Example III of WO-A-9934917. The C₅+ fraction (liquid at ambient conditions) of the product thus obtained was continuously fed to a hydrocracking step (step (a)). The C₅+ fraction contained about 60 wt % C₃₀+ product. The ratio C₆₀+/C₃₀+ was about 0.55. In the hydrocracking step the fraction was contacted with a hydrocracking catalyst of Example 1 of EP-A-532118. The effluent of step (a) was continuously distilled under vacuum to give light products, fuels and a residue “R” boiling from 370° C. and above. The conversion of the product boiling above 370° C. into product boiling below 370° C. was between 45 and 55 wt %. The residue “R” was recycled to step (a). The conditions in the hydrocracking step (a) were: a fresh feed Weight Hourly Space Velocity (WHSV) of 0.8 kg/l·h, recycle feed WHSV of 0.4 kg/l·h, hydrogen gas rate=1000 Nl/kg, total pressure=40 bar, and a reactor temperature in the range of from 330° C. to 340° C.

The obtained fuels fraction (C5⁺—370° C.) was continuously distilled under at a pressure of in between 50 to 70 mbara and at a temperature of from 125 to 145° C. in the top section of the column to give a gas oil fraction as the bottom product.

The physical properties are given in Tables 1 and 2.

TABLE 1
Fischer-Tropsch derived gas oil

| | |
|---|---|
| Kinematic viscosity at 40° C. | 2.531 |
| According to ASTM D445 [mm²/s] | |
| content of aromatics | <0.1 |
| According to IP 391 [% m/m] | |
| content of n-paraffins | 15-25 |
| according to GCxGC - internal | |
| testing methodology [% m/m] | |
| content of isoparaffins | 75-85 |
| according to GCxGC - internal | |
| testing methodology [% m/m] | |
| content of nitrogen according to ASTM | 0.0001 |
| D-5762-98 [% w] | |
| content of sulphur according to ASTM | <0.2 |
| D5453 [mg/kg] | |
| Pour point according to ASTM | −36 |
| D97 [° C.] | |
| Cloud point according to ASTM | −27 |
| D2500 [° C.] | |
| Cold Filter Plugging Point (CFPP) | −25 |
| according to IP309 [° C.] | |
| Cetane index according to ASTM | 82.5 |
| D976 [° C.] | |
| Density at 15° C. according ASTM | 779 |
| D4052 [kg/m³] | |
| Flash point according to ASTM | 72 |
| D93 [° C.] | |
| Visual Appearance | Clear and bright |

TABLE 2
Fischer-Tropsch derived gas oil comprising
paraffins having 9 to 25 carbon atoms

| BP according to | Wt. % according to |
|---|---|
| ASTM D86 | ASTM D86 recovered |
| [° C.] | at or boils above |
| 177 | IBP |
| 202 | 5 |
| 209 | 10 |
| 267 | 50 |
| 326 | 90 |
| 337 | 95 |
| 342 | FBP |

TABLE 3

| | Test | |
|---|---|---|
| Property | protocol | Results |
| Biodegradation | | |
| Aerobic | OECD 301F | 75%, readily biodegradable |
| Biodegradability | | |
| in freshwater | | |
| Aerobic | OECD 307 | Biotic system: |
| Biodegradability | | DT₅₀ = 22.4 days for |
| in soil | | soils initially |
| | | dosed with 1000 mg/kg |
| | | Sterile system: |
| | | DT₅₀ = 82.6 days for |
| | | soils initially |
| | | dosed with 1000 mg/kg |
| Aquatic Toxicity | | |
| Daphnia magna | OECD 211 | 21 d EL₅₀ = 32-100 mg/L |
| | | WAF NOEL = 32 mg/L WAF |
| Pimephales promelas | OECD 210 | 33 d NOEL ≧100 mg/L WAF |
| Sediment Organism toxicity | | |
| Chironomus riparius | OECD 218 | 28 d EC₅₀ >1000 mg/kg |
| | | (dry weight basis) |
| | | NOEC ≧1000 mg/kg |
| | | (dry weight basis) |
| Terrestrial Ecotoxicity | | |
| Earthworms | OECD 207 | >1000 mg/kg dry weight soil |
| (Eisenia foetida) | | |
| Soybean (Glycine max) | OECD 208 | Based on seeding emergence: |
| Tomato | | All 21 d EC₅₀ >1000 mg/kg |
| (Lycopersicon esulentum) | | dry weight soil |
| Mustard (Sinapis alba) | | All 21 d NOEC 1000 mg/kg |
| Oat (Avena sativa) | | dry weight soil |
| Perennial ryegrass | | Based on plant growth: |
| (Lolium perenne) | | All 21 d EC₅₀ >1000 mg/kg |
| | | dry weight soil with the |
| | | exception of perennial |
| | | ryegrass (NOEC 560 mg/kg |
| | | soil dry weight) |

DT50=Disappearance time 50 is the time within which the concentration of the test substance is reduced by 50%. Disappearance time includes both physical and biological losses.

EL50=Loading rate used to prepare WAF which causes a 50% adverse effect to the exposed species over the given time.

NOEL=No Observed Effect Level—Lowest loading rate used to prepare WAF (water accommodated fraction) in which no adverse effects seen in the exposed organism.

EC50=Concentration which causes a 50% adverse effect to the exposed species over the given time.

NOEC=No observed effect concentration—Lowest test concentration in which no adverse effects seen in the exposed organisms.

### Example 2

### Use of Fischer-Tropsch Derived Gas Oil as a Diluent Oil/Base Oil for Solvent and/or Functional Fluid Applications

The properties of the Fischer-Tropsch derived gas oil as given in tables 1 to 3 are the critical properties for the advantage use of the Fischer-Trospch derived gas oil in drilling fluids, heating fuels, lamp oil, barbeque lighters, concrete demoulding, pesticide spray oils, water treatment, cleaners, polishes, car dewaxers, electric discharge machining, transformer oils, silicone mastic, two stroke motor cycle oil, metal cleaning, dry cleaning, lubricants, metal work fluid, aluminium roll oil, explosives, chlorinated paraffins, heat setting printing inks, Timber treatment, polymer processing, rust prevention oils, shock absorbers, greenhouse fuels, fracturing fluids and fuel additives formulations.

Experiments with a Fischer-Tropsch derived gas oil with the properties as given in Tables 1 to 3 were performed in lamp oil, heating fluid, BBQ fluids and electric discharge machining and transformer oils applications.

| | Critical properties | Advantages with respect |
|---|---|---|
| End-use | for end-use | to crude derived gas oil |
| Heating fuels | High smoke point | High smoke point of |
| (non-industrial | low odour | Fischer-Tropsch derived |
| Lamp oil, | No carbonization | gas oil >50 mm ASTM D1322 |
| BBQ fluids | Low aromatics | Low sooting when extinguishing |
| | | and burning, clean burning, |
| | | stable flame |
| | | Low odour during ignition |
| | | Smoke point of Crude oil |
| | | derived gas oil = 19 mm |
| | | ASTM D1322 |
| | | Smoke point of ShellSol |
| | | D70 ™ = 45 mm according to |
| | | ASTMD1322 |
| Electric | Good di-electric | Electric breakdown event |
| discharge | properties | according to ASTM 1816 = |
| machining, | Transparent | 66 KV/2.5 mm |
| transformer | Low viscosity | ShellSol D70 ™ = |
| oils | Low volatility | 55 kV/2.5 mm* |
| | Low odour | ShellSol D100 ™ = |
| | High flashpoint | 60 kV/2.5 mm* |
| | High oxidation | |
| | stability | |
| | Low skin irritancy | |

*ShellSol D70 ™and ShellSol D100 ™are obtained from Shell Chemicals.

### Discussion

The results in tables 1 and 2 show that a Fischer-Tropsch derived gas oil with a low pour point, low viscosity and high flash point was obtained. Further, table 3 shows that the Fischer-Tropsch derived gas oil readily biodegrades, and has low aquatic toxicity, low sediment organism toxicity and low terrestrial ecotoxicity.

The chemical nature, physical property and ecotoxicology of the Fischer-Tropsch derived gas oil indicate that the use of Fischer-Tropsch derived gas oil provides advantages in solvent and functional fluid applications. The results in table 4 indeed show that the Fischer-Tropsch derived gas oil (See Table 4: higher smoke point and higher electric breakdown event) was advantageously used in lamp oil, heating fluid, BBQ fluids, and electric discharge machining and transformer oils applications compared to the use of crude oil derived gas oil in the same applications.

1. Fischer-Tropsch derived gas oil having an initial boiling point of at least 165° C. and a final boiling point of at most 365° C.

2. Fischer-Tropsch derived gas oil according to claim 1, having an initial boiling point of at least 170° C.

3. Fischer-Tropsch derived gas oil according to claim 1, having a final boiling point from 333 to 351° C.

4. Fischer-Tropsch derived gas oil according to claim 1, having a 10 vol. % boiling point from 198 to 220° C. and a T90 vol. % boiling point from 319 to 333° C.

5. Fischer-Tropsch derived gas oil according to claim 1, having a density at 15° C. according to ASTM D4052 from 774 to 779 kg/m³.

6. Fischer-Tropsch derived gas oil according to claim 1, having a kinematic viscosity at 40° C. according to ASTM D445 from 2.3 to 2.8 cSt.

7. Fischer-Tropsch derived gas oil according to claim 1, having a pour point according to ASTM D97 below 10° C.

8. Fischer-Tropsch derived gas oil according to claim 1, having a flash point according to ASTM D93 of at least 68° C.

9. Fischer-Tropsch derived gas oil according to claim 1, wherein the Fischer-Tropsch derived gas oil has a smoke point according to ASTM D1322 of more than 50 mm.

10. Functional fluid comprising a Fischer-Tropsch derived gas oil according to claim 1, further comprising an additive compound.

11. A diluent or base oil for solvent and/or functional fluid formulations comprising a Fischer-Tropsch derived gas oil as defined according to claim 1.

12. (canceled)
